(19) United States
(12) Patent Application Publication
(10) Pub. No.: US 2004/0116182 A1
(43) Pub. Date: Jun. 17, 2004

(54) Health game apparatus capable of playing game using software or the internet

(76) Inventor: Sang-Ho Kim, Kangnam-Ku (KR)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/469,887

(22) PCT Filed: Mar. 7, 2002
(86) PCT No.: PCT/KR02/00398

(30) Foreign Application Priority Data
Mar. 9, 2001 (KR) 2001/12295
Mar. 13, 2001 (KR) 2001/6677 U
Oct. 8, 2001 (KR) 2001/61946

(51) Int. Cl. A63F 9/24; G06F 19/00

(52) U.S. Cl. 463/36

(57) ABSTRACT

An athletic apparatus with a function of allowing a user to play a game using software or internet is disclosed. This apparatus has a front fork and rear frame provided on support frame, a wheel disc having a driven sprocket, two pedal posts, three rotating members rotatably combined by a transmitting member, a reciprocating air pump rotatably supported on the rear frame and accumulated by means of crank member concentrically integrated with the middle member of the rotating members, an air accumulating element variably stored by means of the air pump, and a braking mechanism temporarily activated by air pressure control unit connected to the air accumulating element.

### TECHNICAL FIELD

The present invention relates to a modification of a bicycle which is driven by human power, for example, a user's pedaling action, and more particularly to a health game apparatus which is adapted to allow a player to enjoy a game using a software or the Internet while the player exercises, and which enables a player to monitor an amount of exercise lie has performed by observing an amount of air proportionally accumulated in the air accumulator by actuation of a transmission member wound around a driving member, an intermediate member and a driven member by his pedaling action.

### BACKGROUND ART

A bicycle, which is widely produced these days, is equipped with a pair of crank arms coupled to an axle of a sprocket of a transmission member with a phase difference of 180°, and pedals coupled to the crank arms, and is adapted to run in such a way that the pair of pedals are rotated by player's pedaling motion causing the sprocket to be rotated and the torque of the sprocket is transmitted to its rear wheel via the transmission member.

The torque of the axle of the sprocket is a product of a distance between the axle and the pedal and a force applied in a tangential direction on a rotating trajectory of the pedals. However, since there is a limit to a power which can be produced by human's legs, it is necessary to lengthen crank arms and increase a distance between an axle of a sprocket and a pedal in order to increase the torque of the axle of the sprocket.

Since a diameter of a rotating trajectory of pedals in a conventional bicycle is determined according to a length of human's legs, if a length of crank arms is increased more than that of existing crank arms, there are various inconveniences in that pedaling action becomes difficult and stability is deteriorated.

When turning force of a sprocket is transmitted to a rear wheel, the rear wheel is rotated together with a front wheel. Because of a space occupied by the front and rear wheels, it is inconvenient to handle the bicycle and to exercise with the bicycle in the home, and there is fear of children being injured by the rear wheel.

Furthermore, since a conventional bicycle type health apparatus is impossible for an exerciser (referred to as a player hereinafter) to see his exercise amount, the player is apt to be tired. Therefore, it is impossible to efficiently exploit the health apparatus, and a player tends to leave the health apparatus as it is.

### DISCLOSURE OF THE INVENTION

Accordingly, the present invention has been made keeping in mind the above problems occurring in the prior art, and an object of the present invention is to provide a health game apparatus which is not adapted to obtain exercise effect by simple rotation of wheels resulting from pedaling action, but is adapted to allow a player to exercise while allowing the player to monitor his exercise amount, and which is adapted to transmit turning force of a rear wheel to an air pump operated by a transmission member without loss of the turning force, thereby obtaining more stable turning force than that of a conventional bicycle.

Another object of the present invention is to provide a health game apparatus which is additionally provided with various sensors to output signals detected by the sensors to a set-top box, thereby realizing a key-input device for a game application program.

In order to accomplish the above object, the present invention provides a health game apparatus including a body of the apparatus, which is comprised of a plurality of frames provided at its upper portion with a saddle and a head tube with a main frame disposed therebetween,

wherein the head tube has a steering shaft therein, which is rotatably inserted thereinto and is provided at its upper end with a handle bar 17,

wherein a pair of front forks are fixedly mounted at their upper portions on the main frame adjacent to the steering shaft by means of support brackets,

wherein the front forks are connected to their lower ends to a support frame, by which transmission means is operatively supported, the transmission means being extended to a front part from a rear part of the health game apparatus, and being intended to transmit torque produced from pedals rotated by a player to an object to be rotated,

wherein the transmission means comprises a driving member concentrically mounted on a rotating shaft of the pedals, and a driven member and an intermediate rotating member adapted to be rotated together with a flywheel by the driving member via a transmission member such as a chain and a belt,

wherein the support frame is branched into a pair of branch frames, which are longitudinally extended and parallel to each other at a floating section of the support frame to support the front fork, and which are bent downwardly and rearwardly, the bent branch frames being extended rearwardly while being widened laterally while being spaced apart from the front fork, and then joined to each other at a rear end of the health game apparatus,

the health game apparatus comprising:

a reciprocating air pump including a piston rod rotatably coupled at its one end to a rotating plate, which is rotatably supported together with the intermediate rotating member, and pivotally connected to a rear frame coupled to the support frame;

a suspension frame pivotally coupled to the support frame and disposed at a position opposite to the rear frame, which is rotated by the reciprocating air pump serving as an air source;

an air accumulator rotatably coupled between the suspension frame and the support frame;

means for applying braking force to the flywheel by a pressure of air accumulated in the air accumulator by movement of the transmission member wound around the driving member, the intermediate rotating member and the driven member, caused by user's pedaling.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a side view of a health game apparatus according to the present invention;

FIG. 2 is a block diagram showing a schematic circuit of the health game apparatus according to the present invention;

FIG. 3 is side view of the health game apparatus according to the present invention, in which a saddle and a handle bar are removed;

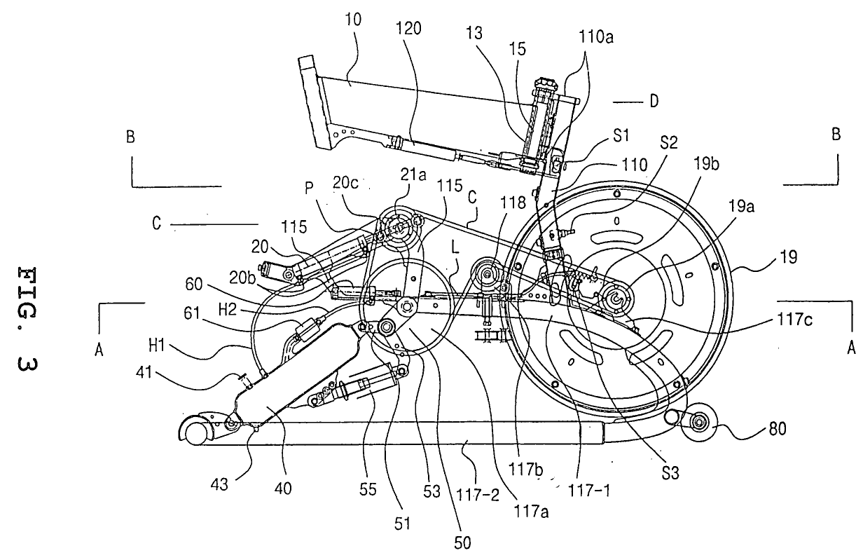

FIG. 4 is a view taken along line A-A of FIG. 3;

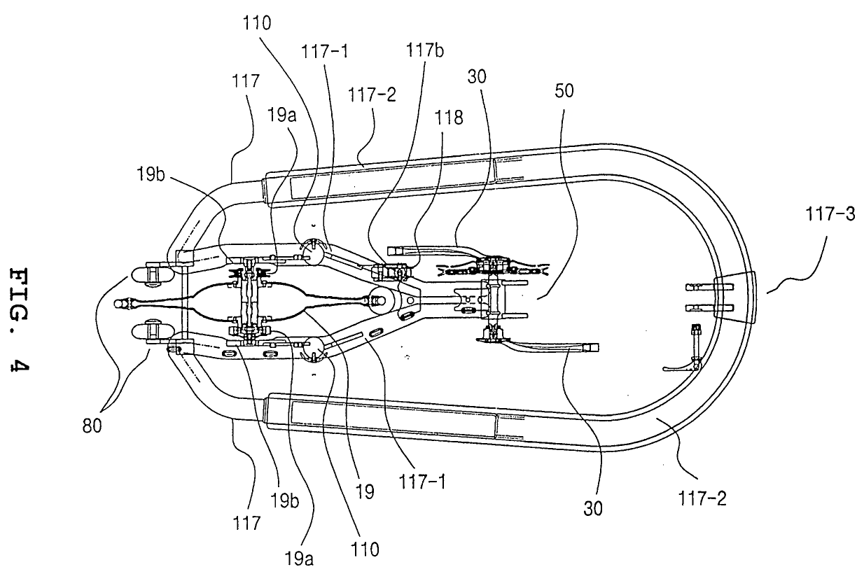

FIG. 5 is a view taken along line B-B of FIG. 3;

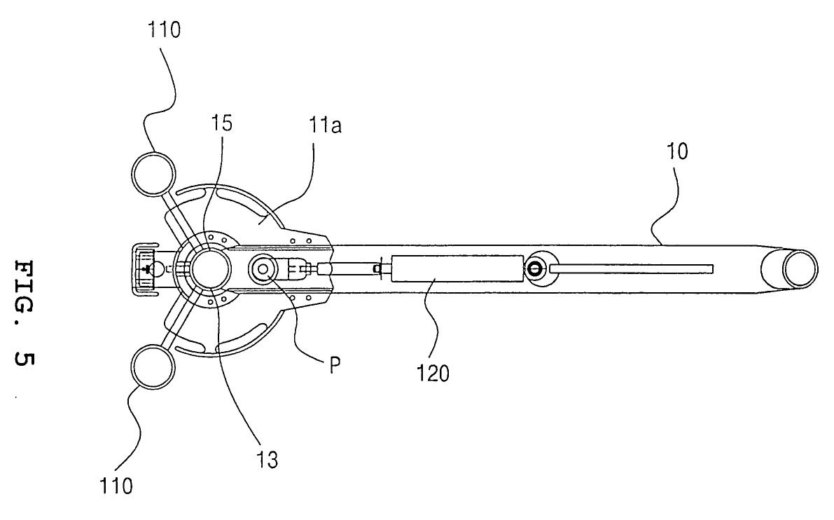

FIG. 6 is a view taken along line C-C of FIG. 3;

FIG. 7 is a view taken along line D-D of FIG. 3;

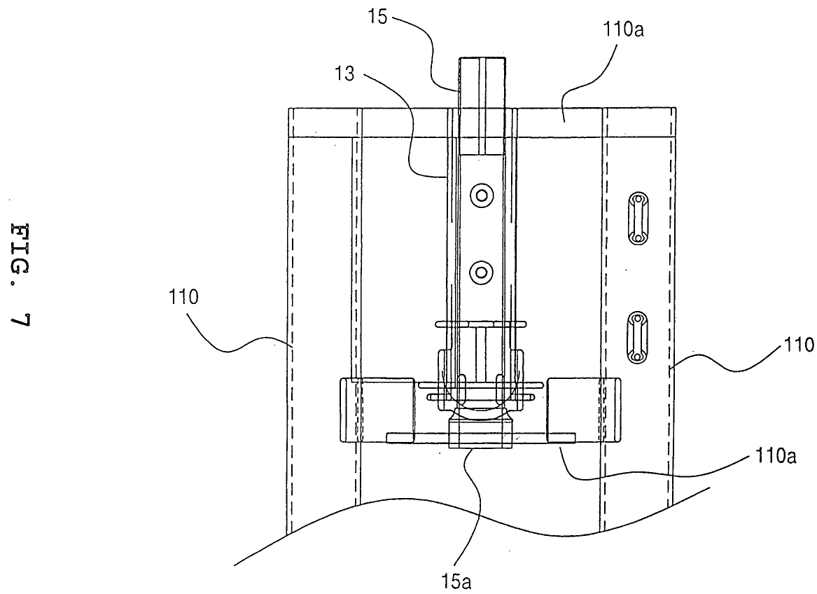

FIG. 8 is a view schematically showing. components associated with a structure for controlling braking force according to the present invention; and

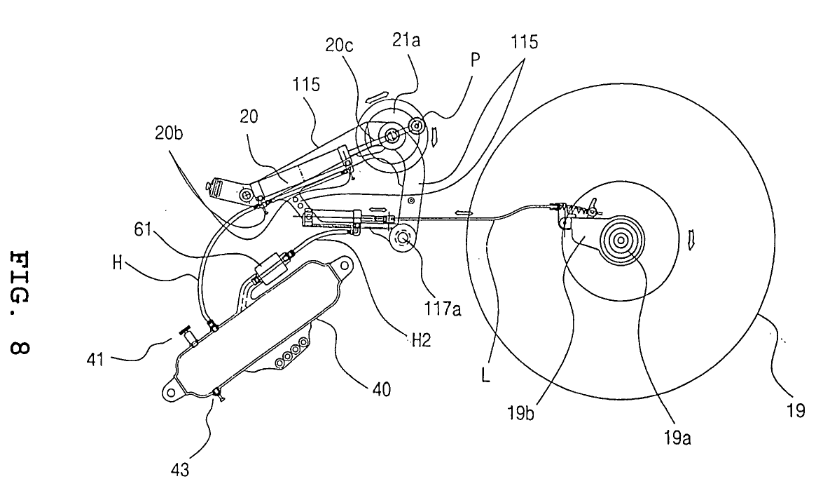

FIG. 9 is a schematic view of FIG. 8 showing an operation of an air pump according to the present invention.

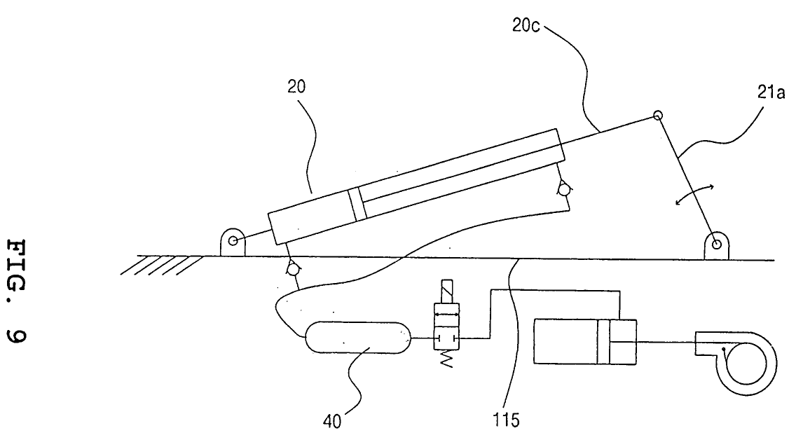

### BEST MODE FOR CARRYING OUT THE INVENTION

This invention will be described in further detail by way of example with reference to the accompanying drawings.

A health game apparatus according to the present invention is provided with a saddle 11.

A body of the apparatus, which is comprised of a plurality of frames. is provided at its upper portion with a saddle 11 and a head tube 13 with a main frame 10 disposed therebetween.

A steering shaft 15 is rotatably inserted into the head tube 13.; The steering shaft 15 is provided at its upper end with a handle bar 17.

A pair of front forks 110 are fixedly mounted at their upper portions on the main frame 10 adjacent to the steering shaft 15 by means of support brackets 110a.

The front forks 1 10 are connected to their lower ends to a support frame 117, by which transmission means 200 is operatively supported. The transmission means 200 is extended to a front part from a rear part of the health game apparatus, and is intended to transmit torque produced from pedals 30 rotated by a player to an object to be rotated.

The transmission means 200 comprises a driving member 30a concentrically mounted on a rotating shaft of the pedals, a driven member 19a and an intermediate rotating member 21a adapted to be rotated by the driving member 30a via a transmission member “C” such as a chain and a belt, and a tension control member 118 rotatably supported to the support frame 117 via a second shaft support member 117b to control tension of the transmission member “C” wound around the driving member 30a, the driven member 19a and the intermediate rotating member 21a.

The driving member 30a, the tension control member 118 and the intermediate rotating member 21 a may be surrounded by an enclosure.

The support frame 117 includes a landing section 117-2 to be in contact with a floor and a floating section 117-1 bent upwardly and then rearwardly to be parallel to the landing section 117-2. The floating section 117-1 of the support frame 117 is provided with a first shaft support member 117a for rotatably supporting the driving member 30a, the second shaft. support member 117b for rotatably supporting the tension control member 117a, and a third shaft support member 117c for rotatably supporting a shaft of a flywheel 19 in this order from the rear.

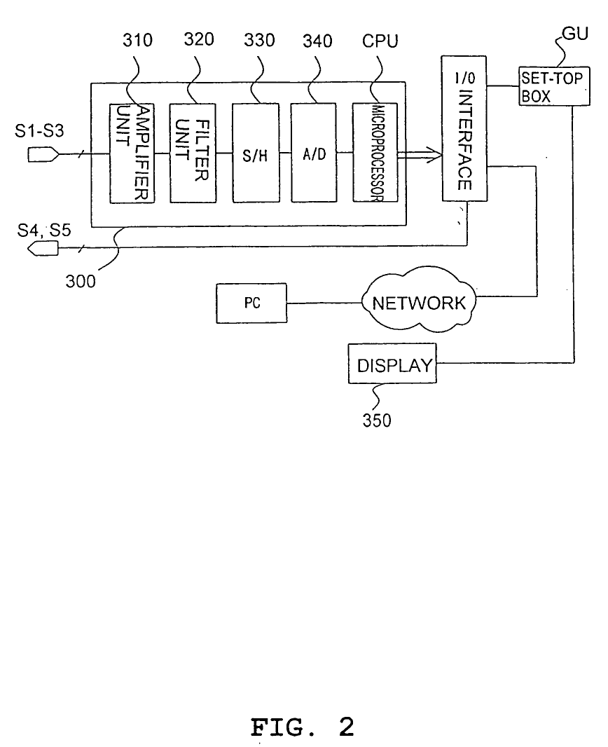

The support frame 117 is branched into a pair of branch frames, which are longitudinally extended and parallel to each other at its floating section to support the front fork 110, and which are bent downwardly and rearwardly. The bent branch frames arc extended rearwardly while being widened laterally with a space from the front fork 110, and then joined to each other by means of a coupling member 117-3 (see FIG. 2).

The driven member 19a together with the flywheel 19 are rotatably supported to the third shaft support member 1 17c.

A pair of pedals 30, 30 coupled to the driving member 30a are rotatably supported to an end of the floating section 117-1 of the support frame 117 via the first shaft support member 117a.

The floating section 117-1 of the support frame 117 is provided at its end with a rear frame 115, which is bent to allow a reciprocating air pump 20 to be mounted thereon. The reciprocating air pump 20 includes a piston rod 20c, which is rotatably coupled at its one end to an end of a crank arm 21 by a pin, in which the crank arm 21 is rotatably supported to the end of the support frame 117 together with the intermediate rotating member 21a. The reciprocating air pump 20 is pumped by the piston rod 20c, which is reciprocated by rotation of the crank arm 21 coupled to the intermediate rotating member 21a to which torque of the driving member 30a is transmitted via the transmission member “C”.

A suspension frame 50 is pivotally coupled to a rotation shaft of the driving member 30a of the support frame 117 and disposed at a position opposite to the rear frame 115, which is rotated by the reciprocating air pump 20 serving as an air source.

An air accumulator 40 is rotatably coupled between the suspension frame 50 and the landing section 117-2 of the support frame 117, which communicates with check valves 30b provided at the both ends of the reciprocating air pump 20 via an air hose “H1” and accumulates air therein by pumping action of the reciprocating air pump 20.

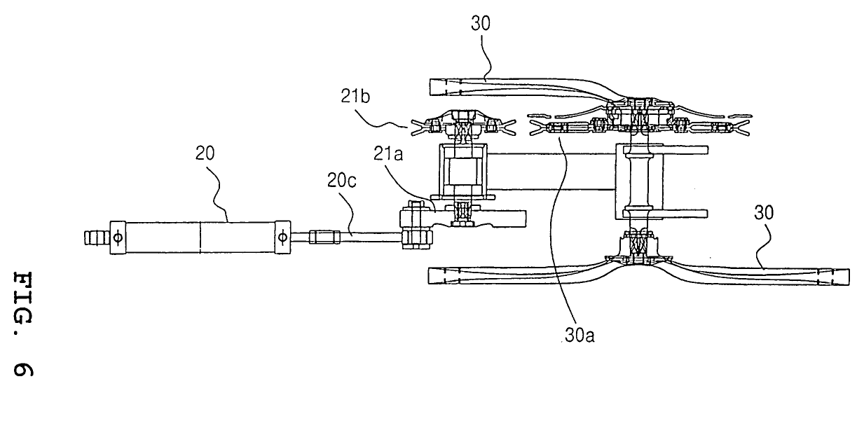

As the intermediate rotating member 21a is actuated as a driving lever, a connecting point “P” of the crank arm 21 is rotated about its rotating axis so that a piston rod 20c of a piston 20b received in a cylinder 20a of the reciprocating air pump 20 is reciprocated, thereby embodying reciprocating slider crank mechanism (see FIG. 6).

The air accumulator 40 communicates with the air pump 20 via the connection hose “H1” and the check valves 20b to receive air from the air pump 20.

The driving member 30a is supported to the support frame 117 by the suspension frame 50.

The steering shaft 15 is coupled to first elastic means 120 at the other end via a rotating lever 15a so that the steering shaft 15 is restored to its normal position after being rotated. The first elastic means 120 may-be comprised of a shock absorber or compression coil spring for applying elastic force.

The suspension frame 50 is branched into two branch frames, i.e., a first branch frame 51 and a second branch frame 53 at its center portion. The first branch frame 51 is hingedly connected to the air accumulator 40, and the second branch frame 53 is connected to the air accumulator 40 at its one end and connected to second elastic means 55 at the other end.

The second elastic means 55 is comprised of a shock absorber or a compression coil spring for applying biasing force in a direction.

The air accumulator 40 is connected to a braking force proportioning cylinder unit 60 such as a single brake cylinder via a second hose “H2” to operate a band brake 19b associated with the driven member 19a mounted on the floating section 117-1 of the support frame 117 so that the driven member 19a is braked by air pressure produced by the pumping action of the air pump 20.

The second hose “H2” is provided with a solenoid valve 61, which is adapted to be opened and closed by a microprocessor to intermittently operate the band brake 19b to afford drag feeling to a user when the user plays a game for running on a mountain or an uneven roadway.

The air accumulator 40 is provided with a pressure-reducing valve 41, which is adapted to discharge air to reduce air pressure in the air accumulator 40 when air pressure in the air accumulator 40 is increased more than a predetermined value by air supplied from the air pump 20 by user's pedaling, so that the reduced air pressure is persistently maintained even after the air pressure is reduced.

The support frame 117 is provided at its bent portion with casters 80 to allow the health game apparatus to be moved.

The air accumulator is connected to the braking force proportioning cylinder unit 60 via the solenoid valve 61 and the second hose “H2”. The braking force proportioning cylinder unit 60 is adapted to pull a brake band of the band brake 19b concentrically coupled to the driven member 19a, by multi-step air discharge, to increase resistance force against rotation of the pedals, thereby increasing exercise effect, when the amount of air accumulated in the air accumulator exceeds a predetermined value or a game is set to a stage of running on a slope way or an uneven roadway. The air accumulator 40 is provided at its lower end with a drain plug 43 for discharging condensed water and foreign substances.

The braking force proportioning cylinder unit 60 may be connected to a block brake concentrically coupled to the driven member 19a, instead of the band brake.

The braking force proportioning unit 60.with a piston rod 61a is longitudinally coupled to the rear frame 115 of the health game apparatus.

The driving member 30a, the driven member 19a and the intermediate rotating member 21 a are comprised of pulleys when the transmission member “C” is a belt, but they are comprised of sprockets when the transmission member “C” is a chain.

The air accumulator 40 may be comprised of an air tube or an air tank.

There are a plurality of detector units “S1, S2, - - - ” for detecting manipulating signals corresponding to displacement or rotation of the health game apparatus.

There is also a key-input device for outputting signals detected by the detector units “S1, S2, - - - ” to a set-top box “GU” to control a game.

The detector units “S1, S2, - - - ” include a rotation number sensor “S1” attached to the steering shaft 15 to detect a rotation degree by a stroke of the handle bar 17, a speed sensor “S2” attached to the front fork 110 associated with the flywheel 19 to detect a rotating speed of the flywheel 19 rotated by user's pedaling action, a displacement sensor “S3” for detecting a displacement of a brake pad 17b which is pivotally actuated by a wire being reciprocated in a cable “L” by a brake lever 17a hingedly coupled to both ends of the handle bar 17, and a microprocessor (CPU) for sending control signals to the set-top box “GU” including a game unit to control a game according to signals detected by the sensors “S1, S2, - - - ”.

An input device is connected to a signal processing unit 300 having components as shown in FIG. 2 to process signals relating to player's motion inputted through the sensors “S1, S2, - - - , including a pointer device such as a joystick).

The signal-processing unit 300 is provided at its front end with an amplifier 310 to amplify inputted weak signals. There is a filter unit 320 for filtering unwanted signal such as noise from the amplified signals.

In addition, there are an S/H unit 330 for sampling signals filtered by the filter unit 320 and an AID converter 340 for converting the sampled signals into digital signals. The digital signals are sent to the microprocessor (CPU) to control an image displayed on a display unit 350.

In this embodiment, though the signals of the game input device are described to be processed in a software manner, the signals may be processed using a TTL logic.

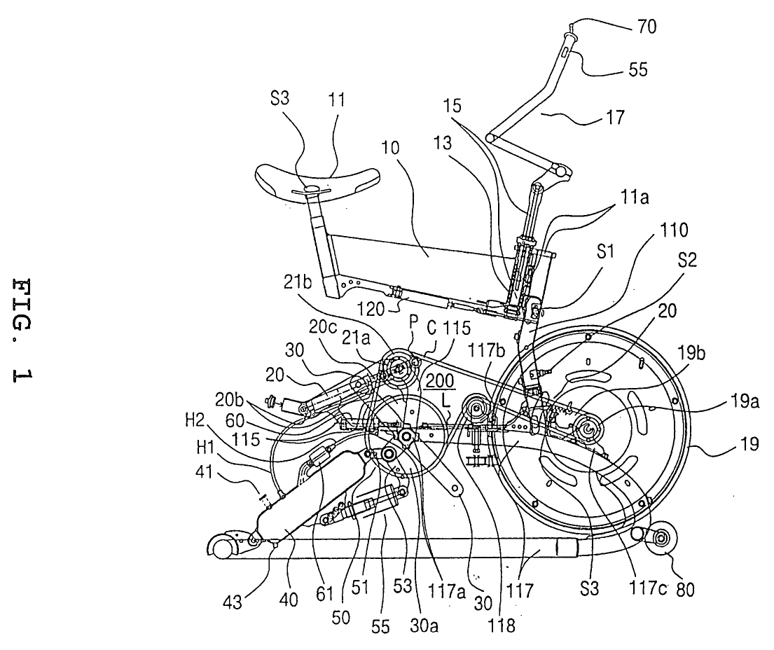

As seen in FIG. 1, data signals are sent to a plurality of peripheral devices through a signal line to demand transmission or response of information required for the game. By the transmission or response, vibrators “S4, S5” are operated. The vibrators “S4, S5” are embedded in the saddle 11 and the handle bar 17 to provide a player with vibrating feeling as if the player runs on an uneven roadway during a motor racing game.

Operations of the vibrators “S4, S5” are controlled by the microprocessor (CPU). In other words, when a player runs on an uneven roadway in the game, a control signal outputted from an input-output interface is inputted. Each of the vibrators “S4, S5” is comprised of a motor, and an eccentric weight coupled to a shaft of the motor.

Functions of the present invention will now be described.

As a player sits on the saddle 11 and alternately operates the pair of pedals 30, 30, the driving member 30a, the intermediate member 21a and the driven member 19a, which are engaged with the transmission member “C” wound therearound, are rotated.

Consequently, the flywheel 19 coupled to the driven member 19a is rotated. At this point, a signal is detected by the speed sensor “S2” for detecting a rotational speed of the flywheel 19 to increase or reduce a speed in an application program such as a motor racing, and is outputted to the microprocessor (CPU).

The rotation number sensor “S1”, which is attached to the steering shaft 15, detects a rotating degree by stroke of the handle bar 17, and outputs the signal corresponding to the rotating degree to the microprocessor (CPU) to control directional change in a motor racing game by rightward and leftward turning of the handle bar 17.

The displacement sensor “S3”, which is adapted to detect a displacement of the Wire which is. reciprocated in the cable “L” by the brake lever 17a hingedly coupled to the handle bar 17, detects user's braking motion, and outputs a signal for reducing a speed in the motor racing game to the microprocessor (CPU) to allow the signal to be pulsed.

The signals detected by the sensors “S1, S2, - - - ” serve as a driving pulse signal source, so that the game is controlled by a control unit comprised of the sensors.

A plurality of sensors for a video game are prepared, and the detected signals are sent to an input interface of the microprocessor (CPU) by an existing keyboard or an existing joystick. When signals from plurality of sensors “S1, S2, - - - ” of the health game apparatus are outputted to the input interface of the microprocessor, the microprocessor produces signals in response to signal generated by a joystick or a keyboard and the sensors according to the present invention to display an image of a player on a video display. The waveforms are combined with various activities in the game to control the game.

When a player enters a stage of running on an uneven roadway or a slope way, a message queue relating to the running condition is produced, so that the solenoid valve 61 is intermittently operated by the microprocessor (CPU). Therefore, an air pressure in the air accumulator 40 is transmitted to the braking force proportioning cylinder unit 60, and thus the piston rod 61 is retracted while pulling the brake band, thereby affording braking force of a certain value to the driving member 30a.

At this point, since the air pressure transmitted to the braking force proportioning cylinder unit 60 from the air accumulator is controlled in incremental steps, a player can exercise while controlling consumption of his physical strength in multiple stages.

Accordingly, it is possible to increase or reduce resisting force against player's pedaling in multiple stages, and to allow a player to monitor his physical effort from an actuating amount of the braking force proportioning cylinder unit 60 due to air supply from the air accumulator.

Consequently, by signals detected by the sensors “S1, S2, - - - ” attached to displacing portions and rotating portions of the health game apparatus, control objects or characters are instructed, so the objects or characters can obtain specified motions such as a turning motion. Alternatively, since a player can easily operate a desired control unit by mounting a joystick 70 on the handle bar 17, an excellent health game apparatus which can overcome disadvantages such as confusion in manipulation of the control unit.

In addition, the health game apparatus enables a player to enjoy a game by the Internet or a software while enabling the player to exercise.

Industrial Applicability

As described above, according to the present invention, by affording specified motions to objects or characters in game application programs or interrupting key values in the application program by pointing input, the game application programs are processed all together, and thus the games can be applied. Furthermore, since a player can monitor his exercise amount by observing an amount of air accumulated in the air accumulator by his pedaling, the player can enjoy a game while exercising.

1. A health game apparatus including a body of the apparatus, which is comprised of a plurality of frames, is provided at its upper portion with a saddle and a head tube with a main frame disposed therebetween,
wherein the head tube has a steering shaft therein, which is rotatably inserted thereinto and is provided at its upper end with a handle bar 17,
wherein a pair of front forks are fixedly mounted at their upper portions on the main frame adjacent to the steering shaft by means of support brackets,
wherein the front forks are connected to their lower ends to a support frame, by which transmission means is operatively supported, the transmission means being extended to a front part from a rear part of the health game apparatus, and being intended to transmit torque produced from pedals rotated by a player to an object to be rotated,
wherein the transmission means comprises a driving member concentrically mounted on a rotating shaft of the pedals, and a driven member and an intermediate rotating member adapted to be rotated together with a flywheel by the driving member via a transmission member such as a chain and a belt,
the health game apparatus comprising:
a reciprocating air pump including a piston rod rotatably coupled at its one end to a rotating plate, which is rotatably supported together with the intermediate rotating member, and pivotally connected to a rear frame coupled to the support frame;
a suspension frame pivotally coupled to the support frame and disposed at a position opposite to the rear frame, which is rotated by the reciprocating air pump serving as an air source;
an air accumulator is rotatably coupled between the suspension frame and the support frame;
means for applying braking force to the flywheel by a pressure of air accumulated in the air accumulator by movement of the transmission member wound around the driving member, the intermediate rotating member and the driven member, caused by user's pedaling.

2. The health game apparatus as set forth in claim 1, wherein the means for applying braking force comprises:
a braking force proportioning cylinder unit such as a single brake cylinder communicating with the air accumulator via a second hose to operate a band brake associated with the driven member mounted on an upper portion of the support frame so that the driven member is braked by supplying air pressure produced by the pumping action of the air pump, via a first hose; and
a solenoid valve connected to the second hose and adapted to be opened and closed by a microprocessor to intermittently operate the band brake to afford drag feeling to a player when the player enjoys a game of running on a mountain or an uneven roadway.

3. The health game apparatus as set forth in claim 1, further comprising a tension control member for controlling tension of the transmission member wound around the driving member, the driven member and the intermediate rotating member.

4. The health game apparatus as set forth in claim 1, wherein the steering shaft is coupled at the other end to first elastic means coupled to the main frame, via a rotating lever, so that the steering shaft is restored to its normal position after being rotated.

5. The health game apparatus as set forth in claim 1, wherein the driving member is supported to the support frame by a suspension frame, and wherein the suspension frame is branched into a first branch frame and a second branch frame at its center portion, the first branch frame being hingedly connected to the air accumulator, and the second branch frame being connected to the air accumulator at its one end and connected to second elastic means at the other end.

6. The health game apparatus as set forth in claim 1, wherein the air accumulator is provided with a pressure-reducing valve, which is adapted to discharge air to reduce air pressure in the air accumulator when air pressure in the air accumulator is increased more than a predetermined value by air supplied from the air pump by a user's pedaling, so that the reduced air pressure is continuously maintained even after the air pressure is reduced.

7. The health game apparatus as set forth in claim 1, wherein the support frame is provided at its bent portion with a caster to allow the health game apparatus to be moved.

8. The health game apparatus as set forth in claim 1, wherein the support frame is branched into a pair of branch frames, which are longitudinally extended and parallel to each other at a floating section of the support frame to support the front fork, and which are bent downwardly and rearwardly, the bent branch frames being extended rearwardly while being widened laterally to be spaced apart from the front fork, and then joined to each other at a rear end of the health game apparatus.

9. The health game apparatus as set forth in any of the preceding claims, wherein the apparatus is provided at its displacing and rotating portions with a plurality of detector units for detecting manipulating signals corresponding to displacement or rotation of the health game apparatus, and provided with a key-input device for outputting signals detected by the detector units to a game unit to control a game, and wherein the apparatus is provided with a microprocessor for processing signals inputted from the key-input device through an input-output interface.

10. The health game apparatus as set forth in claim 9, wherein the detector units include a rotation number sensor attached to the steering shaft to detect a rotation degree by a stroke of the handle bar, a speed sensor attached to the front fork associated with an axle of the flywheel to detect a rotating speed of the flywheel rotated by user's pedaling action, a displacement sensor for detecting a displacement of a brake pad which is pivotally actuated by a wire being reciprocated in a cable by a brake lever hingedly coupled to the handle bar, and a microprocessor for sending control signals to the game unit to control a game according to signals detected by the sensors,
wherein the apparatus is provided with a control unit for processing the game application programs all together by affording specified motions to objects or characters in game application programs or interrupting key values in the application pro(gram by pointing input.

11. The health game apparatus as set forth in claim 9, wherein the saddle and the handle bar are provided with vibrators embedded therein, each having a motor and an eccentric weight.
